(19) United States
(12) Patent Application Publication
(10) Pub. No.: US 2024/0378244 A1
(43) Pub. Date: Nov. 14, 2024

(54) REAL TIME SEARCH FILTERS USING QUANTUM MACHINE LEARNING

(71) Applicant: UNIVERSITY OF SOUTHERN CALIFORNIA, Los Angeles, CA (US)

(72) Inventor: Samuel Gustman, Los Angeles, CA (US)

(73) Assignee: UNIVERSITY OF SOUTHERN CALIFORNIA, Los Angeles, CA (US)

(21) Appl. No.: 18/413,431

(22) Filed: Jan. 16, 2024

Related U.S. Application Data
(60) Provisional application No. 63/442,053, filed on Jan. 30, 2023.
(60) Provisional application No. 63/522,256, filed on Jun. 21, 2023.

(51) Int. Cl. G06F 16/903; G06N 10/60

(52) U.S. Cl. CPC G06F 16/90335; G06N 10/60

(57) ABSTRACT

A system, computer-readable medium, method and apparatus, and/or device for real-time searching and object validation is provided in connection with quantum computing. In various instances, a digital object may be received and may be compared to a library of many digital objects to determine correspondence between the objects according to various factors. Moreover, fixity of objects may be validated.

### CROSS REFERENCE TO RELATED APPLICATIONS

This application is based upon and claims the benefit of and priority to (i) U.S. Provisional Patent Application No. 63/442,053 entitled “REAL TIME SEARCH FILTERS USING QUANTUM MACHINE LEARNING,” filed on Jan. 30, 2023, and (ii) U.S. Provisional Patent Application No. 63/522,256 entitled “QUANTUM LIBRARY SYSTEM USING REAL-TIME FILTERING WITH QUANTUM-ENHANCED SUPPORT VECTOR MACHINES (QSVM),” filed on Jun. 21, 2023. The entire content of each of the aforementioned documents is incorporated by reference herein.

### BACKGROUND

### 1. Field

The following disclosure relates to real-time search filters and more specifically, to real-time search filters using quantum computing.

### 2. Description of the Related Art

In 1954 Arnold Spielberg, Steven Spielberg' s father, invented the Electronic Library System (U.S. Pat. No. 2,885,659). This is the first documented description of a digital library. In 1994, Steven Spielberg started the USC Shoah Foundation. The USC Shoah foundation subsequently collects 52,000 video interviews of Holocaust survivors and witnesses, creating the largest digital library in the world at the time. A new patent called the Digital Library System (U.S. Pat. No. 5,832,499) by Sam Gustman, CTO of the USC Shoah Foundation, was created. Today, a very large collection of electronic library data is maintained by the USC Shoah Foundation. However, large amounts of data are difficult to search, validate, index, excerpt, and retrieve. Thus, there remains a need for improved searching and other functionality for an electronic library.

### SUMMARY

A method of real-time searching using quantum machine learning is provided. The method may include receiving a first input data set from a real-time topic input service. The method may include accessing a database of a plurality of digital objects, each digital object having an associated unique hash, and is indexed by an at least one index in the database. The method may include querying the database by comparing at least a first parameter of the first input data set to the at least one index to identify at least one digital object that is indexed by the at least one index and that satisfies a first relevancy metric relative to the first input data set. The method may include returning the at least one digital object satisfying the first relevancy metric.

In various embodiments one or more further aspect may be provided. For instance, returning at least one digital object may include displaying a combination of the first digital object and at least a portion of the first input data set simultaneously on a user interface device. The first relevancy metric may include at least one of (a) a same word, (b) a shared metadata tag, and/or (c) a similar visual content of an image. Then, at least one index may include one or more of (i) a controlled vocabulary index, (ii) an automated topic model index, and/or (iii) a quantum support vector index. The first input data set may include dynamic real-time data. The real-time topic input service may include a social media data source. The real-time topic input service may include a news wire service. The real-time topic input service may include a machine learning processor ingesting or receiving unstructured data, filtering the unstructured data, and outputting filtered structured data. Then, at least one index may include a set of content parameters associated with each digital object, the set of content parameters including at least one of written words recorded in the digital object, spoken words recorded in the digital object, and/or visual images recorded in the digital object. The method may include comparing the associated unique hash of each digital object with at least one other digital object to identify duplicate digital objects. The method may include deleting one digital object and at least one other digital object to de-duplicate the duplicate digital objects. The associated unique hash may be recorded to a blockchain. The associated unique hash may include a non-fungible token (NFT). The method may include associating the associated unique hash with each digital object by a quantum support vector machine service executing at least one of a machine learning algorithm and/or a quantum computing algorithm. Then querying the database by comparing at least the first parameter of the first input data set to the at least one index may be by a quantum support vector machine service executing at least one of a machine learning algorithm and/or a quantum computing algorithm.

A non-transient computer-readable medium is provided. The medium may have instructions stored thereon that when executed by a processor cause the processor to perform a method of real-time search. The method may include receiving a first input data set from a real-time topic input service. The method may include accessing a database of a plurality of digital objects, each digital object has an associated unique hash, and is indexed by an at least one index in the database. The method may include querying the database, by comparing at least a first parameter of the first input data set to the at least one index to identify at least one digital object that is indexed by the at least one index and that satisfies a first relevancy metric relative to the first input data set. The method may include returning the at least one digital object satisfying the first relevancy metric.

In various embodiments of the medium, one or more aspects may be provided. In various embodiments, the returning of at least one digital object includes displaying a combination of the first digital object and at least a portion of the first input data set simultaneously on a user interface device. In various embodiments, the first relevancy metric includes at least one of (a) a same word, (b) a shared metadata tag, and/or (c) a similar visual content of an image. In various embodiments, the at least one index includes one or more of (i) a controlled vocabulary index, (ii) an automated topic model index, and/or (iii) a quantum support vector index.

A real-time searching system is provided. The system may include a processor configured to receive a first input data set from a real-time topic input service. The system may include a storage service configured to access a database of a plurality of digital objects, each digital object has an associated unique hash, and is indexed by an at least one index in the database and provide the plurality of the digital objects to the processor, the database configured to be queried by the processor by comparing at least a first parameter of the first input data set to the at least one index to identify at least one digital object that is indexed by the at least one index and that satisfies a first relevancy metric relative to the first input data set, and the processor further configured to return the at least one digital object satisfying the first relevancy metric for display on a human-machine interface device.

A method of real-time object validation using a quantum computer is provided. The method may include receiving a first input digital object. The method may include calculating, by the quantum computer, a first input digital object hash associated with a content of the first input digital object. The method may include accessing a database of a plurality of digital objects, each digital object having an associated unique hash. The method may include retrieving the associated unique hash of at least one digital object of the plurality of digital objects. The method may include determining, by the quantum computer, whether at least one digital object having the associated unique hash from among the plurality of digital objects has the associated unique hash that matches the first input digital object hash. The method may include setting a first fixity validation flag associated with the first input digital object in response to the determining step. The first fixity validation flag may be set to a TRUE state or value in response to the associated unique hash matching the first input digital object hash. The first fixity validation flag may be set to a FALSE state or value in response to the associated unique hash not matching the first input digital object hash.

In various embodiments, one or more further aspect of the method may be provided. For example, in various embodiments, the first input digital object is a video file. For example, in various embodiments, the first input digital object is an audio file. For example, in various embodiments, the database of the plurality of digital objects each digital object having the associated unique hash comprises a plurality of NFTs, each NFT having an associated block chain hash function. In various embodiments, each digital object is indexed by at least one index in the database. For example, in various embodiments, the determining by the quantum computer, at least one digital object having the associated unique hash from among the plurality of digital objects includes comparing the associated unique hash of each digital object having the index corresponding to a first input digital object index with the first input digital object hash. In various embodiments, the index includes a metadata tag. In various embodiments, at least an aspect of the quantum computer has a common object request broker architecture (CORBA).

A real-time searching system is provided having a user interface implementing a common object request broker architecture (CORBA). The system may include a processor configured to receive a first input data set from a real-time topic input service. The system may include a storage service configured to: (i) access a database of a plurality of digital objects, each digital object has an associated unique hash, and is indexed by an at least one index in the database, and (ii) provide the plurality of the digital objects to the processor. The database may be configured to be queried by the processor by comparing at least a first parameter of the first input data set to the at least one index to identify at least one digital object that is indexed by the at least one index and that satisfies a first relevancy metric relative to the first input data set. The processor may be further configured to return the at least one digital object satisfying the first relevancy metric for display by a results service on a human-machine interface device. A user interface service may include a manually controllable service to automate workflows among at least (i) the storage service, (ii) the database, and (iii) the processor.

In various embodiments, the user interface includes a dashboard display of (a) the workflows associated with each service and (b) the results service. In various embodiments, the workflows are created by the user interface. The created workflows may be non-pre-existing. The user interface may expose and organize communication between services, create workflows between services, and allow for visualization of service operations, results, and digital collections.

A method of using one or more databases for storing the output of quantum machine learning systems is provided. The method may include persistently storing in a database a set of digital objects that are the results of a query of a results table. The method may include identifying and delivering, using a result service, the set of digital objects to a user interface.

In various embodiments, the results are produced by a set algebra calculation(s) using the index of at least two other collections. Moreover, the method may include processing, using a quantum support vector machines service, the set of digital objects to derive sets of hashed object IDs and comparing the set of digital objects to other sets of digital objects to identify overlap.

The quantum support vector machines service may create vectors for language models that can be used to represent the set of digital objects. The set of digital objects may include object IDs or vectors. The identified IDs can be persistently stored in a primary collection indexing service along with identifying metadata to describe the represented by those IDs. The method may include delivering an index for these objects to the user interface that can be put in the primary collection indexing service for later use. The set of digital objects can be a new collection index on their own through the user interface. The database can be a relational database or a vector database. The result service may include a machine learning processor ingesting or receiving unstructured data, filtering the unstructured data, and outputting filtered structured data.

The user interface may automatically access and connect services together by using a predefined interface definition language to organize communications between the services to produce the desired output from the set of digital objects. The user interface may be a manually controllable service that automates workflows that allow for services to be managed centrally. The user interface may manually allow interactions to occur or automatically allows interactions to occur based on pre-defined relationships via service interfaces.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIGS. 1 and 2 show aspects of a real-time searching system, in accordance with various embodiments;

FIG. 3 shows aspects of a method of real-time searching, in accordance with various embodiments;

FIG. 4 shows aspects of a method of real-time object validation, in accordance with various embodiments;

FIG. 5 shows an example logical data model associated with the real-time searching system, in accordance with various embodiments; and

FIG. 6 shows aspects of a method of using one or more databases for storing the output of quantum machine learning systems.

### DETAILED DESCRIPTION

A system, apparatus and/or method for real time search filters using quantum machine learning is provided. In various embodiments, real-time filtering of pertinent electronic library content and/or incoming real-time data is provided to real time input from several sources to gather lessons from the archive as they pertain to current events. Preservation validation is provided through high-speed hash validation checks to prove original content as the archive is distributed globally, used, and queried.

The next generation of archive technology will allow for content to be verified as unchanged from the moment of capture through the next 100+ years of digital preservation. This disclosure builds on previous concepts of managing digital libraries. This disclosure adds the capabilities of quantum computing to the processing of digital libraries. This verified content will then be catalogued in a way that allows for real-time filter querying. Real-time filter querying changes the suggested information being looked for based on external real-time data. External news, current events, the way people are feeling, responses in classrooms, can all be used as external input to find the most relevant content. A database can have a real-time filter applied that changes the response based on any type of real-time data being used to create new filters. Quantum computing is especially helpful in this in that the machine learning techniques used to query and categorize content such as video can be greatly sped up using Quantum Machine Learning (QML). This is especially important over petabyte and exabyte data sets such as the USC Shoah Foundation's archive of video testimony. High speed real-time filtering of the USC Shoah Foundation's archive will allow for today's events to be augmented with pertinent testimony that teaches lessons of the empathy embodied in the archive and can be applied to collections of many different types of data having many different types of content. This disclosure will also afford benefits by creating a sustainable, power-friendly implementation of digital libraries using artificial intelligence (AI) and machine learning (ML) for search, running more queries with less carbon footprint.

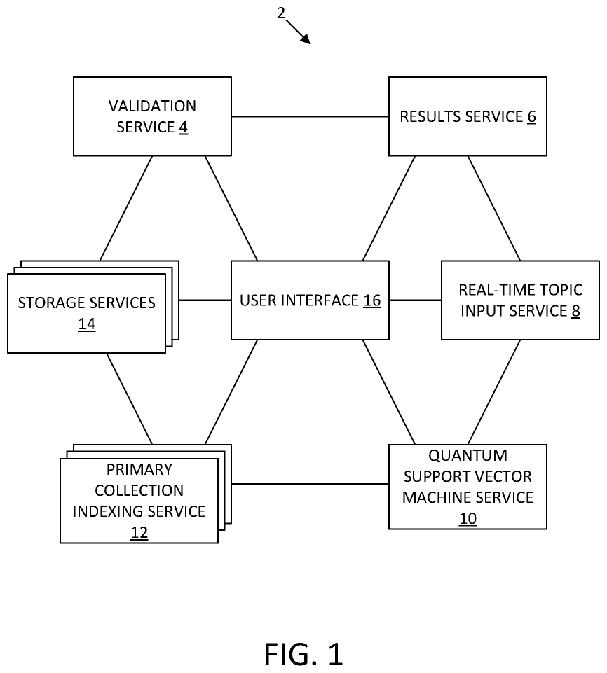

With reference to FIG. 1, a system 2 may include a variety of interconnected objects. Various connections may be added or deleted from among the objects. For instance, in various embodiments a user interface may be utilized by a user to cause the system 2 to interconnect and/or disconnect one or more of the different objects. In various embodiments, the system 2 may include a validation service 4, a results service 6, a real-time topic input service 8, a quantum support vector machine service 10, one or more primary collection indexing service 12, one or more storage service 14, and a user interface 16.

Directing attention to the one or more storage service 14, each collection may work with one or more storage services 14. Each storage service 14 can manage preservation or access to a collection or set of collections. Storage services 14 can also manage access to a collection through streaming. All storage servers of the storage services 14 provide access to hash functions for each digital object. These will be unique for all collections, since no two digital files with differing content should have the same identifying hash function. These hash values will be used by the storage service 14 for preservation services to ensure there is no degradation of content as well as for access services needing validation through a validation service. The hash values can also be used as proof in a blockchain as to the veracity of the digital content.

The storage service(s) 14 interface with the validation service 4, the user interface 16 and/or the primary collection indexing service 12. With the validation service 4, the veracity of a digital object under the storage services 14 can be validated as being an exact representation of the original digital object or not. The user interface 16 can direct all other interactions with the storage services 14, including access, validation, or storage. The storage services 14 hold the digital objects referred to by the primary collection indexing service 12.

Turning attention now to the primary collection indexing service 12, every collection can have more than one indices at any given time. For most collections, one index will be based on a controlled vocabulary for a collection, another will be based on automated topic modeling, and may follow any number of topic modeling techniques. Additional indices may exist with the support of the quantum support vector machine 10, which can rapidly model a collection based on varying content parameters. For example, one index may exist based on the words said, and another based on the images within the content. These indices can be created using manual, binary or quantum modeling.

The ability to store vectors as the output from machine learning to represent a set of digital objects may also be included. In addition, indices may exist with the support of the quantum support vector machine services 10 which can rapidly model a collection based on varying content parameters and store the output vectors in the indexing service. For example, one index may exist based on the words said, and another based on the images within the content. These indices can be created using manual, binary, or quantum modeling.

The index can also be used to look for duplicates between databases, as identical content will generate identical hash values using the same hash algorithm. The index can also be used as input to the real-time topic input service 8 to use one set of data to query another set of data using their indices.

The primary collection indexing service 12 interfaces with the storage services 14, the user interface 16 and the quantum support vector machines services 10. With the storage services 14, the primary collection indexing service 12 holds metadata for a set of digital object IDs within the storage services 14. The user interface 16 can direct all other interactions with the primary collection indexing service 12, including access, validation, or storage. The quantum support vector machine service(s) 10 is used to create unique digital identifiers or hash functions to be stored and organized in the primary collection indexing service 12 for querying.

The quantum support vector machine service (QSVM) 10 leverages quantum algorithms to categorize content using machine learning techniques. On a functioning quantum computer, these algorithms run an order of magnitude faster than on their binary counterparts. This allows for fast indexing of material. These algorithms can be used to create indices for primary collections or process real-time collections of information to cross reference or query an existing database. The output after running a QSVM on a collection of objects may be predicted labels and the probability for whether digital objects are relevant to the query. There can also be accuracy measures available to show how accurate the vector is against a predefined test set. The predicted labels allow for data points to be categorized. For example, news data can be processed for topics and cross referenced with a database, such as a database of the USC Shoah Foundation, to find the most pertinent content (such as clips of videos) to a specific real-time feed of information.

The quantum support vector machine service 10 can generate indices for the primary collection indexing service 12 or the real-time topic input service 8. The quantum support vector machine service 10 can also be used to run hash functions from content to quickly generate hash functions to look for duplicate information.

The quantum support vector machine service 10 interfaces with the user interface 16, the real-time topic input service 8 and the primary collection indexing service 12. The quantum support vector machine service 10 is used to process collections of digital objects, deriving sets of hashed object IDs, and comparing them to other sets of digital objects to identify overlap. The quantum support vector machine service 10 can create vectors for language models that can be used to represent sets of digital objects. These vectors can be stored for query comparison in vector database management systems. All identified IDs can be persistently stored in the primary collection indexing service 12 along with identifying metadata to describe the data represented by those IDs. The real-time topic input service 8 delivers content for ID creation and comparison with other sets of IDs.

Directing attention to the real-time topic input service 8, for topics that will be used to query existing primary sources, a service is needed to collect the data from the querying data set, hand it off to the quantum support vector machines service 10, then deliver the index from the querying topic to the results service 6 to calculate the most pertinent content based on the topics discovered in the querying data set. The indices that are created can be persistently stored by the user interface 16 in the primary collection indexing service 12 for later use as well.

The real-time topic input service 8 interfaces with the user interface 16, the results service 6, and the quantum support vector machines service 10. The user interface 16 sends the querying content to the real-time topic input service 8. The real-time topic input service 8 sends the querying content to the quantum support vector machines service 10 to create Object IDs or a vector as a representation of the digital objects in the querying content. The results service 6 is used to collate the content that is the result of sets of Object IDs, usually the result of querying an existing set of IDs in the primary collection indexing service 12 with a real-time set of IDs produced by the real-time topic input service 8.

The results service 6 interfaces with the validation service, real-time topic input service, and user interface. The results service 6 derives a set of Object IDs and related content based on some form of query or set algebra being performed on the combination of the real-time topic content IDs and existing indices of digital objects from the primary collection indexing service 12. The user interface 16 is responsible for delivering all sets of IDs meant to be queried to the results service 6. For example, a set of objects from a news site on the Internet can be intersected with existing sets of objects to find common digital objects between the two sets. In addition, persistent vectors as the output of a machine learning task can be used to represent a result.

The results service 6 performs set algebra operations on the sets of digital objects. This can be relational, graph, or some other form of discrete mathematical querying system applied to sets of data to create a new set of data. The results service 6 may deliver a set of objects that are the result of some set algebra calculation using the index of two other collections. An index for these objects may also be delivered to the user interface 16 that can be put in a primary collection indexing service for later use.

The real-time topic input service 8 interfaces with the user interface 16, the results service 6, and the quantum support vector machine service 10. The user interface 16 sends the querying content to the real-time topic input service 8. The real-time topic input service 8 sends the querying content to the quantum support vector machine service 8 to create Object IDs as a representation of the digital objects in the querying content. The results service 6 is used to collate the content that is the result of sets of Object IDs, usually the result of querying an existing set of IDs in the primary collection indexing service 12 with a real-time set of IDs produced by the real-time topic input service 8.

Attention is now directed to the validation service 4. The hash of all objects in a primary source collection or a real-time filter collection can be checked using binary or quantum computing against a known hash list. For example, a set of NFTs can be checked against their blockchain hash function before being used to query a primary collection to look for fakes before building the query index.

The validation service 4 interfaces with the results service 6, the storage services 14, and the user interface 16. Any set of results can be validated against the original digital objects to check on whether there has been any change to a digital object. The same can be done with any digital objects in the storage services 14. The user interface 16 can be used to control the validation service 4 and at what times it is applied to digital content.

The validation service 4 is one of the unique aspects of using Quantum computing in a library system. Fixity is the checking of digital objects using their hash to make sure they match the original over time. Fixity protects against corruption either by hacking, system failure or aging of the media the content resides on. Without using a quantum computer, fixity is a very slow process that can take enormous amounts of processing power. A fraction of that is needed with a quantum computing service doing the validation.

Turning now to the user interface 16, one implementation of the Quantum Library system would be using an Object Request Broker (ORB) to create a set of commands that each service can be paired with to use multiple services at once. An object request broker is a type of middleware component that facilitates program calls being made from one computer to another, promoting the interoperability of distributed object systems, with the different parts communicating with the others via the object request broker. An object request broker marshals or serializes data and, particularly in a common object request broker architecture (CORBA) compliant system, may use an interface description language (IDL) to describe the data that is transmitted on remote calls. An ORB can provide a framework to enable remote objects to be used over a network as if the remote objects were local and part of a same process.

The user interface 16 can access and place services together by using a predefined interface description language to organize the communication between services to produce the desired output from sets of digital objects. The user interface 16 may be a human-controllable service that can automate workflows that allow for all services to be managed centrally. All services can be connected to each other through the user interface 16. Dashboard display of workflow information from each service as well as displaying results from the results service 6 is possible through the user interface 16. The user interface 16 can be programmed to create relationships between the various services that were not pre-existing. The user interface 16 exposes and organizes the communication between the services, creates workflows between those services, and allows for visualization of service operations, results, and digital collections.

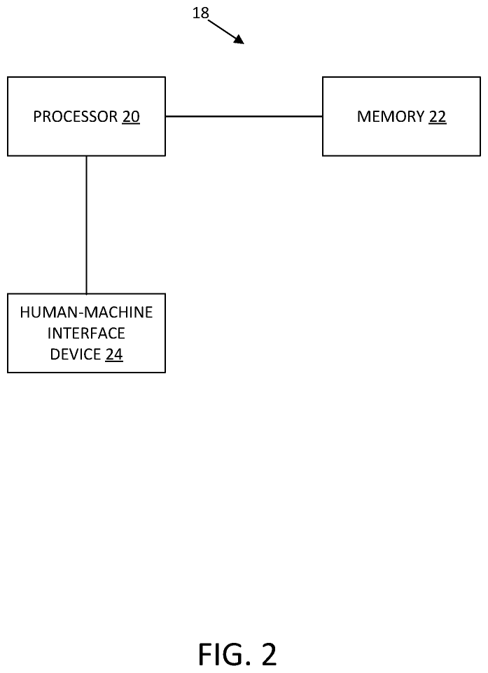

Having introduced various aspects of a system 2, one may appreciate that the system 2 may run on one or more real-time searching system 18 having one or more processor and/or one or more memory. For example, with reference to FIG. 2, a processor 20 and a memory 22 may be provided. The processor 20 may be connected to a human-machine interface device 24, such as a display screen, or other device. In various embodiments, the processor 20 may be a distributed processor, or a combination of processors, one or more of which operate to perform on or more of the aspects (e.g., run all or part of one or more of the services) of FIG. 1. Similarly, in various embodiments, the memory 22 may be a distributed memory, or a combination of memories, one or more of which operate to perform on or more of the aspects (e.g., store data associated with all or part of one or more of the services) of FIG. 1. As such and with reference to both FIGS. 1 and 2, a real-time searching system 18 may include a processor 20 configured to receive a first input data set from a real-time topic input service 8. The system 18 may include a storage service 14 configured to access a database of a plurality of digital objects (e.g., a database in memory 22), each digital object has an associated unique hash, and is indexed by an at least one index in the database and provide the plurality of the digital objects to the processor 20, the database configured to be queried by the processor 20 by comparing at least a first parameter of the first input data set to the at least one index to identify at least one digital object that is indexed by the at least one index and that satisfies a first relevancy metric relative to the first input data set, and the processor 20 further configured to return the at least one digital object satisfying the first relevancy metric for display on a human-machine interface device 24. The persistent database may be a relational database, or an object-oriented database, or a vector database. In various embodiments, a vector database such as Pinecone is implemented.

In various embodiments, a real-time searching system is provided having a user interface implementing a common object request broker architecture (CORBA). In various embodiments, an example CORBA platform is the open-source project omniORB, though other platforms are possible. The system may be a quantum computing system. The system may have various architectures. For example, a Quantum-Optimized Device Architecture (QODA), such as that available from NVIDIA may be implemented. A cloud system such as Azure Quantum, such as that available from Microsoft may be implemented. The system may include a processor configured to receive a first input data set from a real-time topic input service. The system may include a storage service configured to: (i) access a database of a plurality of digital objects, each digital object has an associated unique hash, and is indexed by an at least one index in the database, and (ii) provide the plurality of the digital objects to the processor. The database may be configured to be queried by the processor by comparing at least a first parameter of the first input data set to the at least one index to identify at least one digital object that is indexed by the at least one index and that satisfies a first relevancy metric relative to the first input data set. The processor may be further configured to return the at least one digital object satisfying the first relevancy metric for display by a results service 6 on a human-machine interface device. Finally, the system may include a user interface service comprising a manually controllable service to automate workflows among at least (i) the storage service, (ii) the database, and (iii) the processor. The user interface may be a dashboard display of (a) the workflows associated with each service and (b) the results service. The workflows may be created by the user interface. The created workflows may be non-pre-existing. The user interface may (a) expose and organize communication between services, (b) create workflows between services, and (c) allow for visualization of service operations, results, and digital collections.

An example implementation of the system may include various features and may be described in terms of user requirements in the following paragraphs. For instance, with regard to user digital object authentication, a service for calculating hash functions and looking for like content would allow for mass object authentication in digital collections. The service may be called by the user interface when a user wants to ensure that the user is using the original unchanged objects in a set or sets for querying. The service may retrieve the hash functions from a public block chain to check public collections, or a maintained list of fixity hash values in the storage service for objects known by the quantum library system.

A user may query one set of digital objects with another. In an example of this type of query, a user of a collection of audiovisual testimonies collected from the Ukrainian war against Russia may query against testimonies from the Holocaust where survivors of Holodomor and Nazi persecution in the former Soviet Union talk about their experiences. The query will be able to find testimonies from the Holocaust collection that are relevant to topics in the Ukrainian War collection.

In this case, since there is not a linear separation between the two collections, but many topics that may be separated into more than two groups, one may utilize a non-linear support vector machine (SVM) algorithm to identify like groupings of content between the two collections. In fact, there may be many different non-linear separation calculations performed to identify all of the relevant groupings between the collections. This is where the speed of a QSVM provides significant benefits. For example, performing many five-fold cross-validations to perform the query using non-quantum SVMs would be very time consuming and not reasonably feasible. However, assuming a proper quantum computing environment, one can ignore the processing time constraints and assume the calculations are possible in a reasonable timeframe. From the user interface, a set of querying objects may be identified and a set of objects in storage to be queried may be identified. The request to find all areas of similarities between the two sets of objects may be made and returned for access.

In the example query, the user and/or system will have a list of identifying secure hash algorithm (SHA) values (hash values) representing the bits of data expected in the Ukrainian collection to check if the actual digital objects that are expected to be there have been retrieved. This could happen if one retrieves the Ukrainian digital collection from another digital library that offers fixity-based SHA values, so that one can check if the collection is as it was originally stored prior to performing the query.

From the user interface, a workflow that checks the content from the Ukrainian news objects being used in the query against a public block chain containing the hash functions for those objects is checked. If the check returns satisfactory, then an index is created over the Ukrainian collection, and it is used to query the Holocaust testimonies to look for areas of overlap (from a content perspective) using machine learning. The index may be represented in vectors that may be stored persistently, such as in Pinecone. Result sets are returned with the collection of related Ukrainian and Holocaust testimonies to the user interface for use by a user.

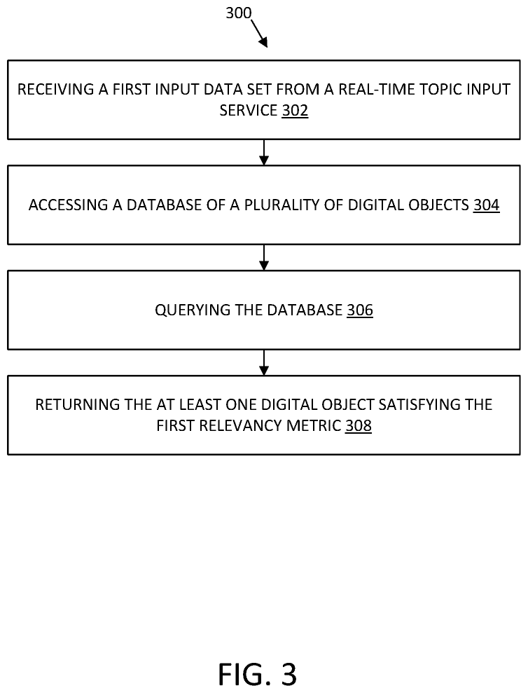

The aforementioned systems may execute one or more methods. For instance, with reference to FIG. 3, a method of real-time searching using quantum machine learning 300 may be provided. The method may include receiving a first input data set from a real-time topic input service (block 302). The method may include accessing a database of a plurality of digital objects, each digital object having an associated unique hash, and indexed by an at least one index in the database (block 304). The method may include querying the database by comparing at least a first parameter of the first input data set to the at least one index to identify at least one digital object that is indexed by the at least one index and that satisfies a first relevancy metric relative to the first input data set (block 306). The method may include returning the at least one digital object satisfying the first relevancy metric (block 308).

In various embodiments, one or more further aspects are provided. For instance, returning the at least one digital object may include displaying a combination of the first digital object and at least a portion of the first input data set simultaneously on a user interface device. The first relevancy metric may at least one of (a) a same word, (b) a shared metadata tag, and/or (c) a similar visual content of an image. The at least one index may be one or more of (i) a controlled vocabulary index, (ii) an automated topic model index, and/or (iii) a quantum support vector index. The first input data set may include dynamic real-time data. The real-time topic input service may be a social media data source. The real-time topic input service may be a news wire service. The real-time topic input service may be a machine learning processor ingesting or receiving unstructured data, filtering the unstructured data, and outputting filtered structured data. The at least one index may be a set of content parameters associated with each digital object, the set of content parameters comprising at least one of written words recorded in the digital object, spoken words recorded in the digital object, and/or visual images recorded in the digital object.

The method may also include comparing the associated unique hash of each digital object with at least one other digital object to identify duplicate digital objects. The method may also include deleting one of the each digital object and the at least one other digital objects to de-duplicate the duplicate digital objects. The associated unique hash may be recorded to a blockchain. The associated unique hash may include a non-fungible token (NFT). The method may also include associating the associated unique hash with the each digital object by a quantum support vector machine service executing at least one of a machine learning algorithm and/or a quantum computing algorithm. The querying the database may be by comparing the at least the first parameter of the first input data set to the at least one index by a quantum support vector machine service executing at least one of a machine learning algorithm and/or a quantum computing algorithm.

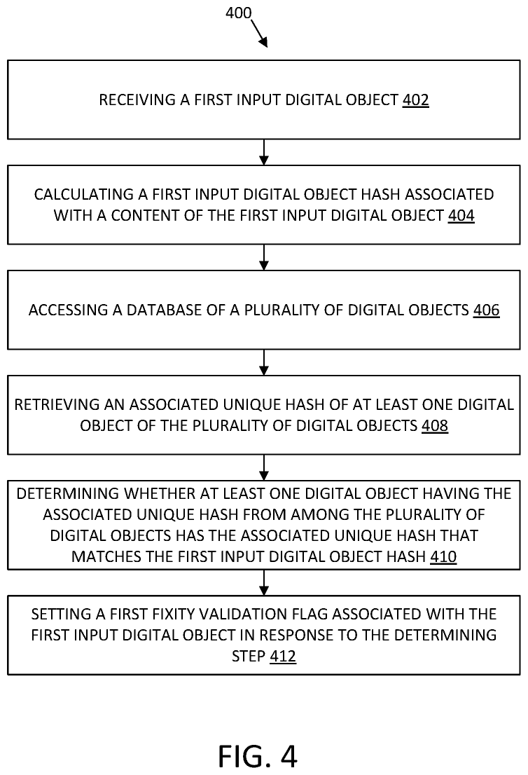

Turning now to FIG. 4, an example method 400 of real-time object validation using a quantum computer is provided. The method may include receiving a first input digital object (block 402). The method may include calculating, by the quantum computer, a first input digital object hash associated with a content of the first input digital object (block 404). The method may include accessing a database of a plurality of digital objects, each digital object having an associated unique hash (block 406). The method may include retrieving the associated unique hash of at least one digital object of the plurality of digital objects (block 408). The method may include determining, by the quantum computer, whether at least one digital object having the associated unique hash from among the plurality of digital objects has the associated unique hash that matches the first input digital object hash (block 410). The method may include setting a first fixity validation flag associated with the first input digital object in response to the determining step (block 412). In various embodiments, the first fixity validation flag is set to a TRUE state or value (e.g., “1”) in response to the associated unique hash matching the first input digital object hash. In various embodiments, the first fixity validation flag is set to a FALSE state or value (e.g., “0”) in response to the associated unique hash not matching the first input digital object hash.

Moreover, in various embodiments one or more further aspect may be provided. For instance, the first input digital object may be a video file. The first input digital object may be an audio file. The database of the plurality of digital objects where each digital object has the associated unique hash, which may be a plurality of NFTs, each NFT having an associated block chain hash function. Each digital object may be indexed by an at least one index in the database. In various embodiments, the determining by the quantum computer, at least one digital object having the associated unique hash from among the plurality of digital objects includes comparing the associated unique hash of each digital object having the index corresponding to a first input digital object index with the first input digital object hash. In various embodiments, the index comprises a metadata tag. At least an aspect of the quantum computer may have a common object request broker architecture (CORBA).

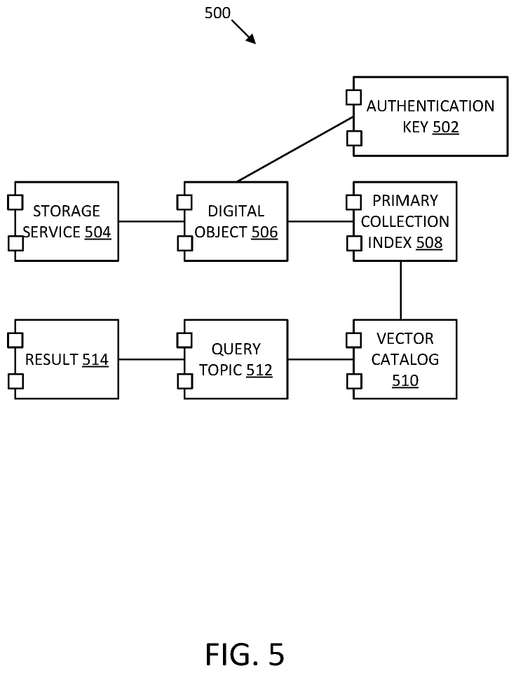

Turning now to FIG. 5, in various embodiments, the system may adopt a data model 500. The data model may include persistent entities to store metadata and content. In various instances, the data model includes a persistent entity corresponding to each aforementioned service. In various embodiments, the persistent entities include an authentication key 502, a storage service 504, a digital object 506, a primary collection index 508, a vector catalog 510, a query topic 512, and a result 514. Other combinations may be contemplated. The storage service 504, the primary collection index 508, and the result 514 may be in direct support of persistence for similarly named corresponding services.

The authentication key 502 may comprise a unique key for each digital object 506 that is calculated using a hash function such as SHA 256. This enables verification of the digital object 506 through the validation service by recalculating the hash and checking that the authentication key has not changed. The storage service 504 may include metadata (for each storage service) and the digital objects managed by each storage service may be identified in a many-to-many relationship. There may be an external storage service (such as a cloud storage vendor) and the digital objects managed by that system is synchronized with the storage service table. The digital object 506 may represent the actual digital object or may represent a pointer to those digital objects in an external storage system. The primary collection index 508 may include persistent storage for the primary collection index service. The indices can be a set of digital objects or vectors that show a relationship between machine learning spaces. In a relationship space, this may be akin to a view that is constantly updated or updating with new data. However, this may contain vectors from the vector catalog 510 as a representative of an index.

The vector catalog 510 is also illustrated. It is possible to store results of a machine learning language model in a vector database such as Pinecone. These can represent indices of results for digital collections as well as sets of identifiers. This works similar to a dynamic view or query on a data store that updates automatically as new digital objects are added to the query over time.

The query topic 512 is illustrated. The query topic 512 allows for the retrieval of digital objects in a set through using indexed digital object(s) in a catalog or by instantiating the nearest neighbor results in a vector catalog. The real-time topic index receives queries from the user interface and stores them persistently as a query topic for processing by the results service. In addition to being able to search within a set of digital objects in a storage based on a vector or set of new digital objects, vectors themselves can be compared for similarities to provide a result set.

The result 514 is illustrated. The results service 6 persistently stores a set of digital objects that are the results of a query in the result table. These can become a new collection index on their own through the user interface if desired.

While the preferred embodiments of the disclosure have been shown and described, it will be apparent to those skilled in the art that changes and modifications may be made therein without departing from the spirit of the disclosure, the scope of which is defined by the following claims.

In various embodiments, example code sequences corresponding to an interface description language (IDL) of different embodiments may be provided. For instance, an example may be provided as follows.

Typedef sequence<octet> Blob;
struct Vector {
int VectorID; unsigned long length;
sequence<double> elements; };

QLMVector stands for Quantum Language Model Vector and is a persistent vector created by the Quantum Digital Library to represent a set of Digital Objects. The QLMVector holds the output feature data of a QSVM persistently to represent the results of the machine learning analysis on a dataset and define boundaries between classifications. This is where something is identified or catalogued as being relevant.

Typedef Vector QLMVector;
module QSVMClassification { struct TrainingData {
Vector[ ] features;
string[ ] labels; };
struct ClassificationResult {
string predictedLabel;
float confidence; };
interface QSVMClassifier {
QLMVector classify(TrainingData trainingData, Vector[ ] samples); }; };

The Validation Service is used to check the hash values of DigitalObjects to make sure the version or original object is unchanged.

```
  module ValidationService {
  struct DigitalObject {
  int ObjectID;
  string title;
  unsigned long long OriginalHash Value;
  Blob DigitalData;
  unsigned long long LastCalculatedHash Value;
  boolean hashvaluesmatch; };
  interface ValidationService {
  unsigned long long CalculateHash (in Blob DigitalData);
  boolean HashValuesMatch (in unsigned long long OriginalHash Value,
in unsigned long long LastCalculatedHashValue); };
```

The StorageService allows for collections of DigitalObjects or vectors representing DigitalObjects to be stored.

module StorageService {
string StorageName;
string StorageType;
QLMVector StoredVector;
struct DigitalObject {
int ObjectID;
string title;
unsigned long long OriginalHash Value;
Blob DigitalData;
unsigned long long LastCalculatedHashValue;
boolean hashvaluesmatch; }
interface StorageService {
void createObject(in string StorageName, in DigitalObject NewObject);
void deleteObject(in string StorageName, in int ObjectID);
DigitalObject readObject(in string StorageName, in ObjectID, out DigitalObject);
void updateObject(in string StorageName, in DigitalObject NewObject, in ObjectID);
void createVector(in string StorageName, in QLMVector NewVector);
void deleteVector(in string StorageName, in int VectorID);
string getStorageType(out string StorageType);
string getStorageName(out string StorageName); };

Persistent indices for use in search for sets of Digital Objects are kept in the Primary Collection Indexing Service.

module PrimaryCollectionindexingService{
struct Index {
Boolean has Vector;
int IndexID;
string IndexName;
int[ ] ObjectID;
QLMVector[ ] LLMResult; };
interface PrimaryCollectionindexingService {
void createDigitalObjectIndex(in int[ ] ObjectID);
void createVectorIndex (in int[ ] VectorID); };

The Quantum Support Vector Machine Service provides vector results for classification of Digital Objects.

module QuantumSupportVectorMachineService {

// predicted labels, accuracy, and predicted probabilities are input along with the
// query vector to create a new result vector.
struct QSVM {
int IndexID;
QLMVector queryvector;
string[ ] testcollection;
Vector testvector;
String predictedlabel;
Float accuracy;
Float predictedprobability;
QLMMVector VectorResults; };
interface QuantumSupportVectorMachineService {
QLMVector classify(int [ ]IndexID, Digital) };
// The Real Time Topic Input Service prepares a new set of Digital Objects to be put in
// a vector form to be input into the Result Service.
Module RealTimeTopicInputService {
DigitalObject [ ]InputData;
QLMVector outputVector; };
interface RealTimeTopicInputService {
QLMVector classify (in int [ ]InputData.ObjectID) };
module ResultService {
DigitalObject [ ]inputSet;
QLMVector [ ]inputVector;
DigitalObject [ ]querySet;
QLMVector [ ]queryVector;
DigitalObject [ ]resultSet;
QLMVector [ ]resultVector; };
interface ResultService {
void findresult (in DigitalObject [ ]inputSet, in QLMVector inputVector, in
DigitalObject [ ]querySet, in QLMVector queryVector, out DigitalObject [ ]resultSet,
out QLMVector [ ]resultSet) };
module UserInterface {
struct serviceConnector {
string inputService;
string outputService;
DigitalObject [ ]inputSet;
QLMVector [ ]inputSet;
DigitalObject [ ]resultSet;
QLMVector [ ]resultVector; };
interface UserInterface {
// connect two services together to perform some function on DigitalObjects or
// QLMVectors
void workflow (in string inputService, in string outputService, in DigitalObject
[ ]inputSet, in QLMVector [ ]inputSet, out DigitalObject [ ]resultSet, out QLMVector
[ ]resultSet,) };

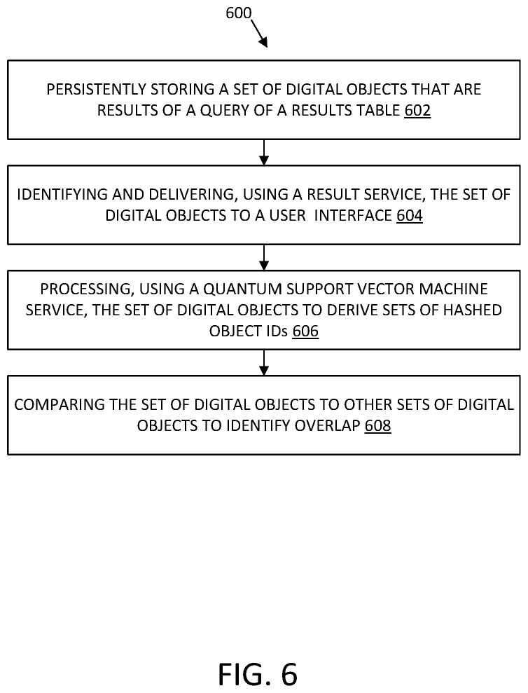

Having discussed various examples, attention is now directed to FIG. 6 for a method 600 of using one or more databases for storing the output of quantum machine learning systems. The method may include persistently storing in a database a set of digital objects that are the results of a query of a results table (block 602). The method may include identifying and delivering, using a result service, the set of digital objects to a user interface (block 604).

In various embodiments, the results are produced by a set algebra calculation using the index of at least two other collections. Moreover, the method may include processing, using a quantum support vector machines service, the set of digital objects to derive sets of hashed object IDs (block 606) and comparing the set of digital objects to other sets of digital objects to identify overlap (block 608).

The quantum support vector machines service may create vectors for language models that can be used to represent the set of digital objects. The set of digital objects may include object IDs or vectors. The identified IDs can be persistently stored in a primary collection indexing service along with identifying metadata to describe the represented by those IDs. The method may include delivering an index for these objects to the user interface that can be put in the primary collection indexing service for later use. The set of digital objects can be a new collection index on their own through the user interface. The database can be a relational database or a vector database. The result service may include a machine learning processor ingesting or receiving unstructured data, filtering the unstructured data, and outputting filtered structured data.

The user interface may automatically access and connect services together by using a predefined interface definition language to organize communications between the services to produce the desired output from the set of digital objects. The user interface may be a manually controllable service that automates workflows that allow for services to be managed centrally. The user interface may manually allow interactions to occur or automatically allows interactions to occur based on pre-defined relationships via service interfaces.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

What is claimed is:

1. A method of real-time searching using quantum machine learning, comprising:
receiving a first input data set from a real-time topic input service;
accessing a database of a plurality of digital objects, each digital object having an associated unique hash, and indexed by an at least one index in the database;
querying the database by comparing at least a first parameter of the first input data set to the at least one index to identify at least one digital object that is indexed by the at least one index and that satisfies a first relevancy metric relative to the first input data set; and
returning the at least one digital object satisfying the first relevancy metric.

2. The method of real-time searching according to claim 1, wherein returning the at least one digital object comprises displaying a combination of the first digital object and at least a portion of the first input data set simultaneously on a user interface device.

3. The method of real-time searching according to claim 1, wherein the first relevancy metric comprises at least one of (a) a same word, (b) a shared metadata tag, and/or (c) a similar visual content of an image.

4. The method of real-time searching according to claim 1, wherein the at least one index comprises one or more of (i) a controlled vocabulary index, (ii) an automated topic model index, and/or (iii) a quantum support vector index.

5. The method of real-time searching according to claim 1, wherein the first input data set comprises dynamic real-time data.

6. The method of real-time searching according to claim 1, wherein the at least one index comprises a set of content parameters associated with each digital object, the set of content parameters comprising at least one of written words recorded in the digital object, spoken words recorded in the digital object, and/or visual images recorded in the digital object.

7. The method of real-time searching according to claim 1, further comprising comparing the associated unique hash of the each digital object with at least one other digital object to identify duplicate digital objects.

8. The method of real-time searching according to claim 1, further comprising deleting one of the each digital object and the at least one other digital objects to de-duplicate the duplicate digital objects.

9. The method of real-time searching according to claim 1, wherein the associated unique hash is recorded to a blockchain.

10. The method of real-time searching according to claim 1, further comprising, associating the associated unique hash with the each digital object by a quantum support vector machine service executing at least one of a machine learning algorithm and/or a quantum computing algorithm.

11. The method of real-time searching according to claim 1, wherein the querying the database by comparing the at least the first parameter of the first input data set to the at least one index is by a quantum support vector machine service executing at least one of a machine learning algorithm and/or a quantum computing algorithm.

12. A method of real-time object validation using a quantum computer, comprising:
receiving a first input digital object;
calculating, by the quantum computer, a first input digital object hash associated with a content of the first input digital object;
accessing a database of a plurality of digital objects, each digital object having an associated unique hash;
retrieving the associated unique hash of at least one digital object of the plurality of digital objects;
determining, by the quantum computer, whether at least one digital object having the associated unique hash from among the plurality of digital objects has the associated unique hash that matches the first input digital object hash; and
setting a first fixity validation flag associated with the first input digital object in response to the determining step,
wherein the first fixity validation flag is set to a TRUE state in response to the associated unique hash matching the first input digital object hash, and
wherein the first fixity validation flag is set to a FALSE state in response to the associated unique hash not matching the first input digital object hash.

13. The method of real-time object validation according to claim 12, wherein the first input digital object comprises at least one of a video file and an audio file.

14. The method of real-time object validation according to claim 12, wherein the plurality of digital objects have the associated unique hash, which may be a plurality of NFTs, each NFT having an associated block chain hash function.

15. The method of real-time object validation according to claim 12, wherein the determining includes comparing the associated unique hash of each digital object having the index corresponding to a first input digital object index with the first input digital object hash.

16. The method of real-time object validation according to claim 12, wherein the quantum computer has a common object request broker architecture (CORBA).

17. A method of using one or more databases for storing the output of quantum machine learning systems, the method comprising:
persistently storing in a database a set of digital objects that are the results of a query of a results table; and
identifying and delivering, using a result service, the set of digital objects to a user interface.

18. The method for storing the output of quantum machine learning systems according to claim 17, wherein the results are produced by a set algebra calculation using an index of at least two other collections.

19. The method for storing the output of quantum machine learning systems according to claim 17, further comprising processing, using a quantum support vector machines service, the set of digital objects to derive sets of hashed object IDs and comparing the set of digital objects to other sets of digital objects to identify overlap.

20. The method for storing the output of quantum machine learning systems according to claim 17, wherein the quantum support vector machines service creates vectors for language models that can be used to represent the set of digital objects.
